(19) United States
(12) Patent Application Publication
(10) Pub. No.: US 2019/0168719 A1
(43) Pub. Date: Jun. 6, 2019

(54) Systems, Devices, and/or Methods for Managing Water

(71) Applicant: Scott Wright, Severn, MD (US)

(72) Inventor: Scott Wright, Severn, MD (US)

(21) Appl. No.: 16/179,962

(22) Filed: Nov. 4, 2018

Related U.S. Application Data
(60) Provisional application No. 62/554,991, filed on Sep. 6, 2017.

(51) Int. Cl. B60S 1/66

(52) U.S. Cl. CPC B60S 1/66; B08B 3/026

(57) ABSTRACT

Certain exemplary embodiments can provide a system comprising a vehicle. The vehicle comprises a 12 volt DC power outlet that is electrically coupled to a battery of the vehicle. A water tank is mounted inside of a cab of a vehicle. When all doors of the vehicle are closed, the water tank is substantially enclosed by the vehicle cab.

### CROSS-REFERENCES TO RELATED APPLICATIONS

This application claims priority to, and incorporates by reference herein in its entirety, pending U.S. Provisional Patent Application Ser. No. 62/554,991 (Attorney Docket No. 1219-02), filed Sep. 6, 2017.

### BRIEF DESCRIPTION OF THE DRAWINGS

FIGS. 1-13 are executed in color.

A wide variety of potential practical and useful embodiments will be more readily understood through the following detailed description of certain exemplary embodiments, with reference to the accompanying exemplary drawings in which:

FIG. 1 is a perspective view of an exemplary embodiment of a system 1000;

FIG. 2 is a perspective view of an exemplary embodiment of system 1000;

FIG. 3 is a perspective view of an exemplary embodiment of system 1000;

FIG. 4 is a perspective view of an exemplary embodiment of system 1000;

FIG. 5 is a perspective view of an exemplary embodiment of system 1000;

FIG. 6 is a perspective view of an exemplary embodiment of system 1000;

FIG. 7 is a perspective view of an exemplary embodiment of system 1000;

FIG. 8 is a perspective view of an exemplary embodiment of system 1000;

FIG. 9 is a perspective view of an exemplary embodiment of system 1000;

FIG. 10 is a perspective view of an exemplary embodiment of system 1000;

FIG. 11 is a perspective view of an exemplary embodiment of system 1000;

FIG. 12 is a perspective view of an exemplary embodiment of system 1000; and

FIG. 13 is a perspective view of an exemplary embodiment of system 1000.

### DETAILED DESCRIPTION

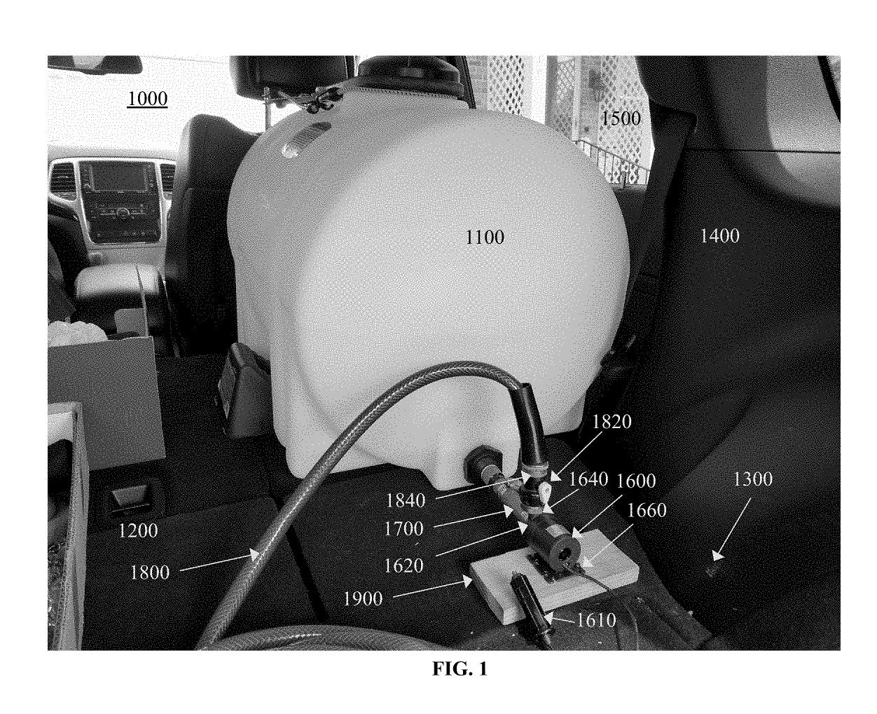

FIG. 1 is a perspective view of an exemplary embodiment of a system 1000, which comprises a water tank 1100 placed inside an exemplary vehicle 1200. Vehicle 1200 comprises a 12 volt DC power outlet 1300, which is electrically coupled to a battery of vehicle 1200.

Water tank 1100 is mounted inside of a cab 1400 of vehicle 1200. When all ports 1500 of vehicle 1200 are closed, water tank 1100 is substantially enclosed by the cab 1400 of vehicle 1200. A pump 1600 can be coupled to water tank 1100. Pump 1600 is constructed to generate water pressure from electrical energy obtained from 12 volt DC power outlet 1300.

An inlet port 1620 of pump 1600 is coupled to a flexible hose 1700. An outlet port 1640 of pump 1600 is coupled to a flexible hose 1800. A base 1900 (which can be made of wood) can coupled to a frame 1660 of pump 1600. A valve 1820 coupled to a discharge line 1840 of pump 1600.

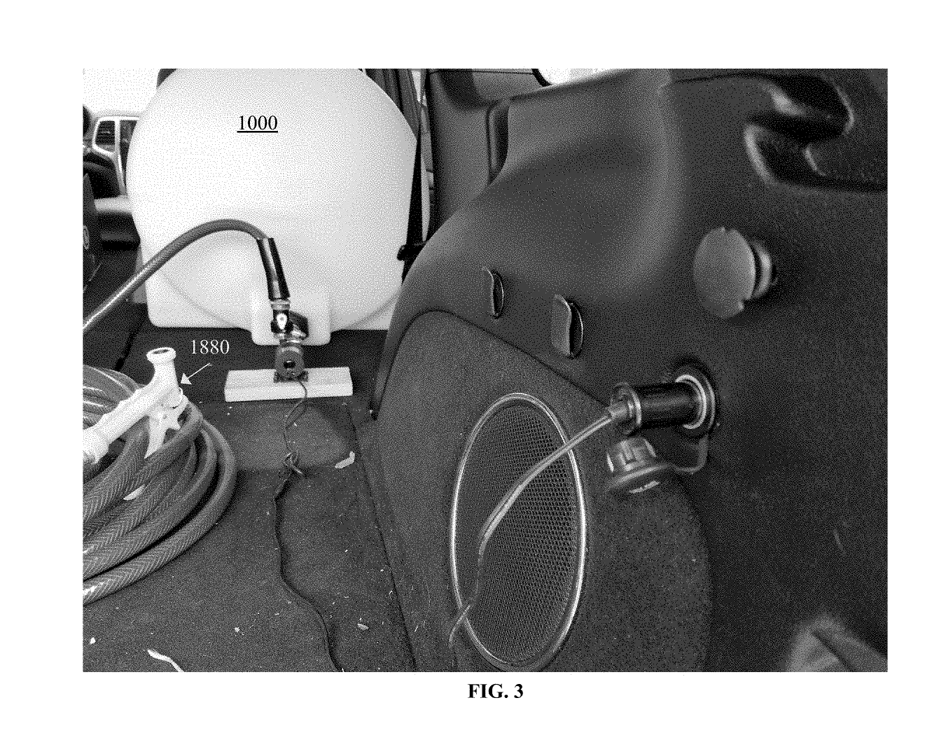

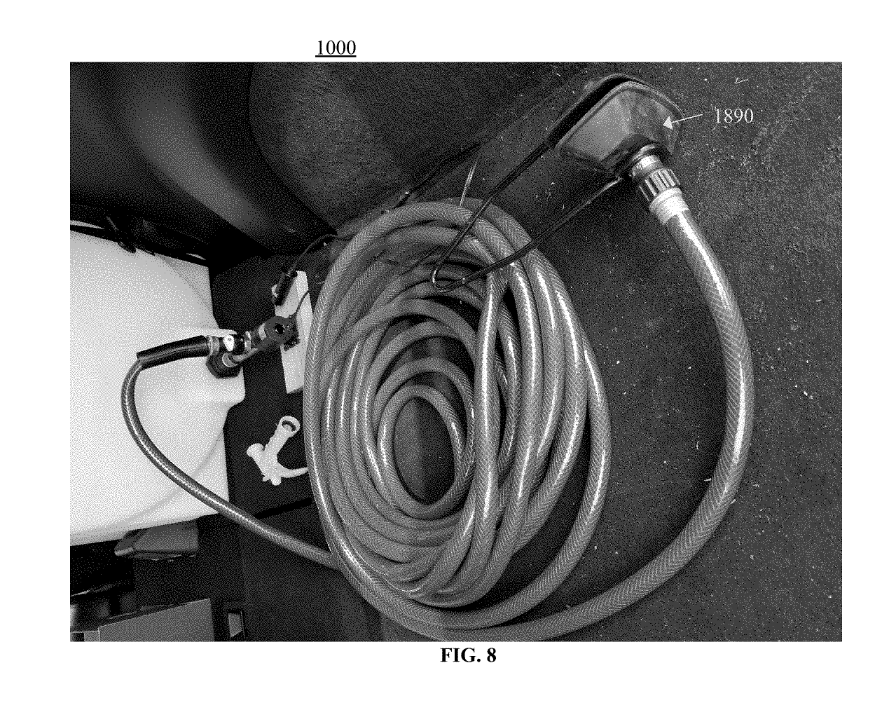

A spray nozzle 1880 (see FIG. 3) coupled to flexible hose 1800, which is coupled to outlet port 1640 of pump 1600. A marine boat motor flusher 1890 (see FIG. 8) can be coupled to outlet port 1640 of pump 1600 via flexible hose 1800.

The illustrated motor vehicle is a sport utility vehicle (“SUV”). Water tank 1100 is coupled to pump 1600. Pump 1600 is coupled to a base 1900 and has flexible hose 1800 coupled to its output. Pump 1600 is powered with electrical energy via a cord that is coupleable to a 12 volt DC power outlet 1300 (e.g., a cigarette lighter receptacle). Water tank 1100 has a fill port via which water can be added to water tank 1100. Certain exemplary embodiments can be relatively light and can weigh approximately 25 to 30 pounds and can be relatively easily moved from one vehicle to another. SUV's, Pickups or possibly even station wagons can hold and/or transport system 1000. System 1000 can be a substantially self-contained 12 v portable flushing/rinsing system.

System 1000 can be used to flush a trailer brake system and/or rinse off a trailer and/or boat, etc. even while such objects are still wet from use.

System 1000 can comprise water tank 1100, pump 1600, a 12 v adapter plug 1610, valve 1820, hose adapters, spray nozzle 1880, and/or marine boat motor flusher 1890, etc.

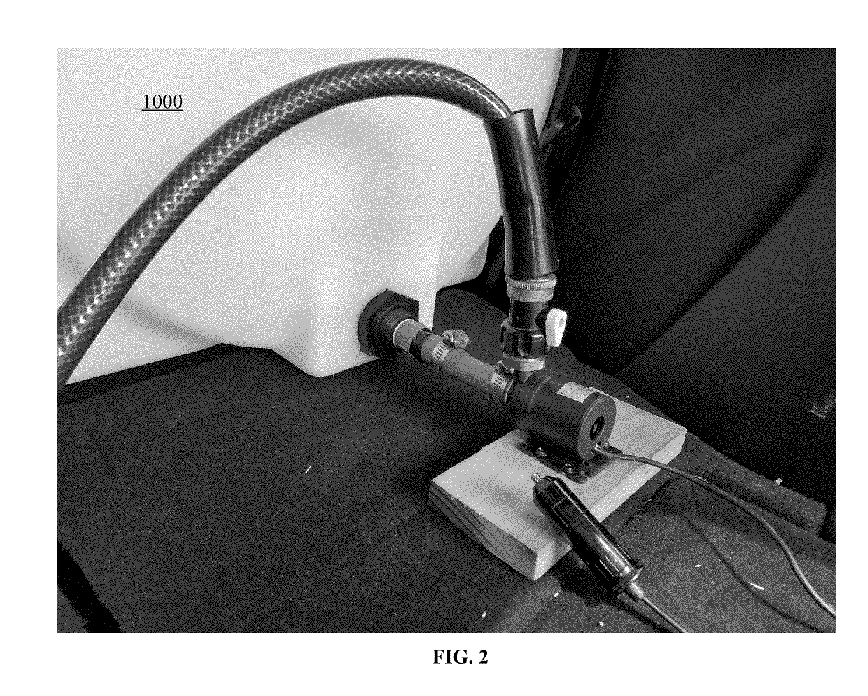

FIG. 2 is a perspective view of an exemplary embodiment of system 1000, which illustrates a magnified view of the water pump as coupled to the water tank. As illustrated the system comprises a valve between the pump and the flexible hose.

FIG. 3 is a perspective view of an exemplary embodiment of system 1000, which illustrates the cord of the water pump coupled to the vehicular electrical receptacle.

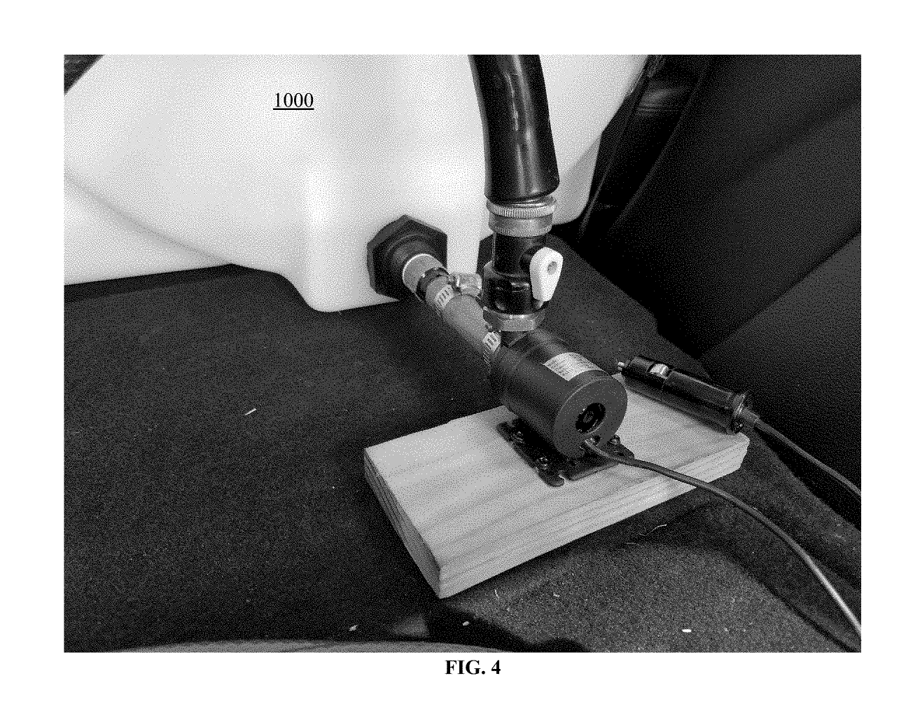

FIG. 4 is a perspective view of an exemplary embodiment of system 1000, which illustrates a magnified view of the water pump as coupled to the water tank. As illustrated the system comprises a valve between the pump and the flexible hose.

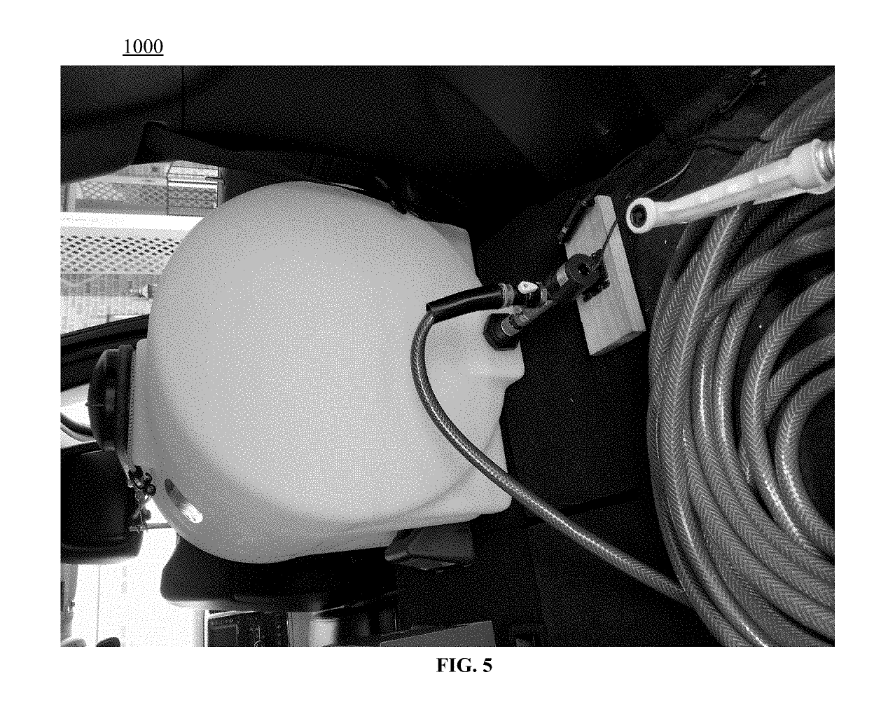

FIG. 5 is a perspective view of an exemplary embodiment of system 1000, which shows another view of the water tank, the water pump, and the flexible hose. The illustrated system shows the flexible hose coupled to a nozzle that directs pumped water conveyed through the flexible hose.

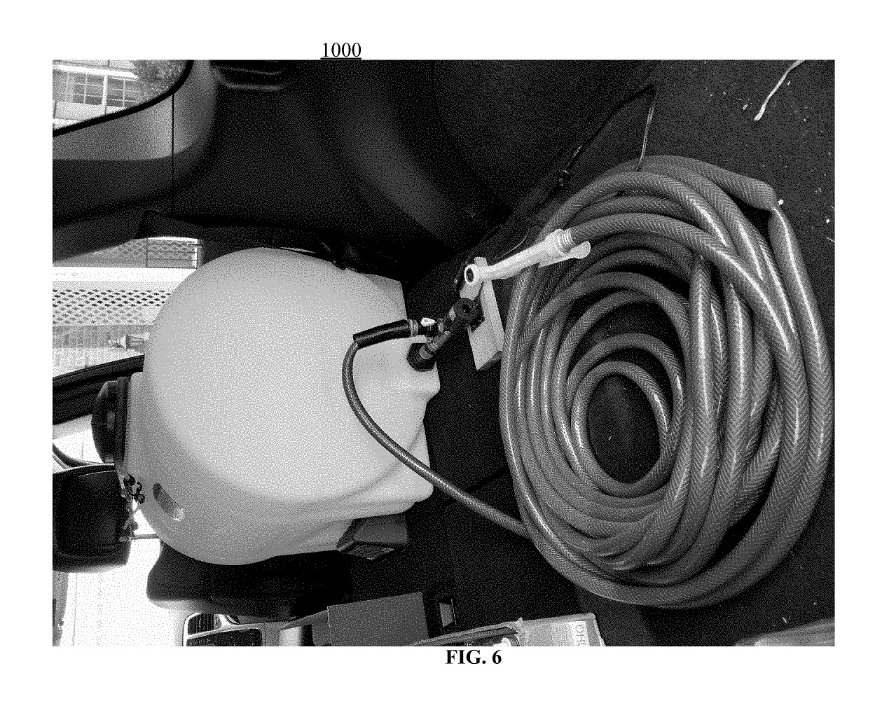

FIG. 6 is a perspective view of an exemplary embodiment of system 1000, which shows another view of the water tank, the water pump, the flexible hose, and the nozzle.

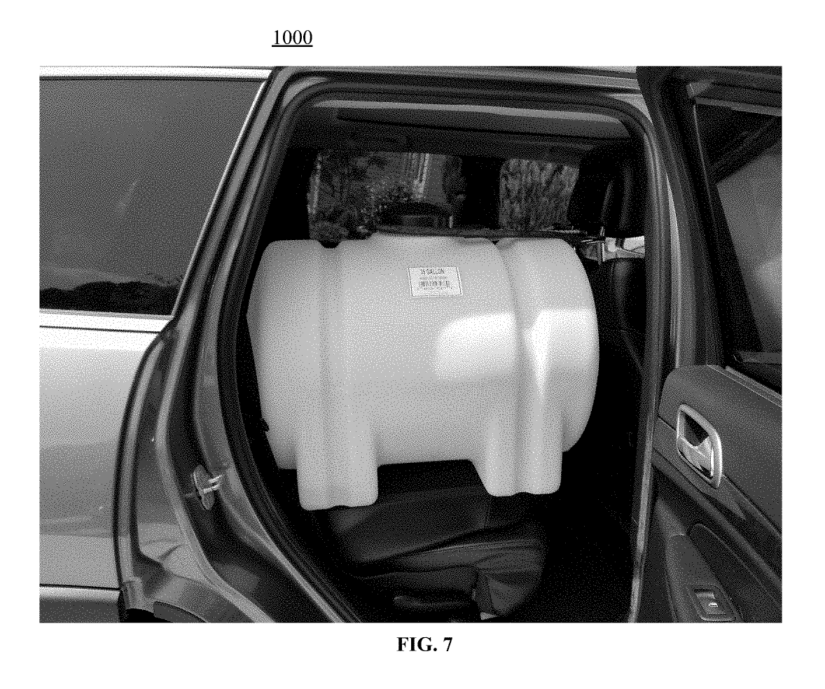

FIG. 7 is a perspective view of an exemplary embodiment of system 1000, which shows a side view of the water tank with a door of the vehicle opened to allow a clear view.

FIG. 8 is a perspective view of an exemplary embodiment of system 1000, which particularly illustrates the garden hose decoupled from the nozzle and coupled to a marine boat motor flusher with rectangular cups. Via the illustrated system, a user can efficiently flush a marine boat motor cooling system. Via system 1000 can also be used to remove salt water from boat and/or boat motor surfaces.

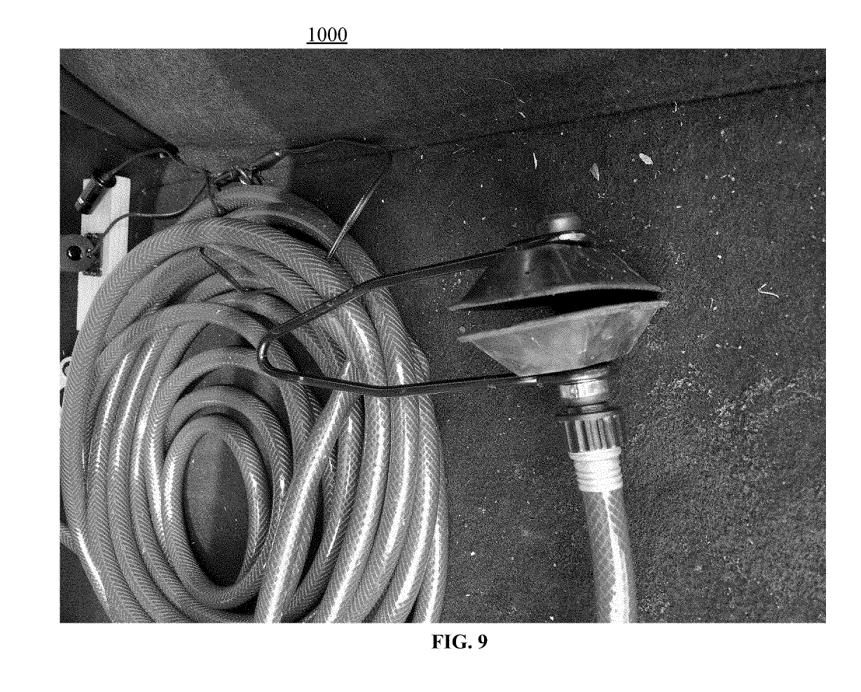

FIG. 9 is a perspective view of an exemplary embodiment of system 1000, which particularly illustrates a close-up view of the garden hose coupled to the marine boat motor flusher with rectangular cups.

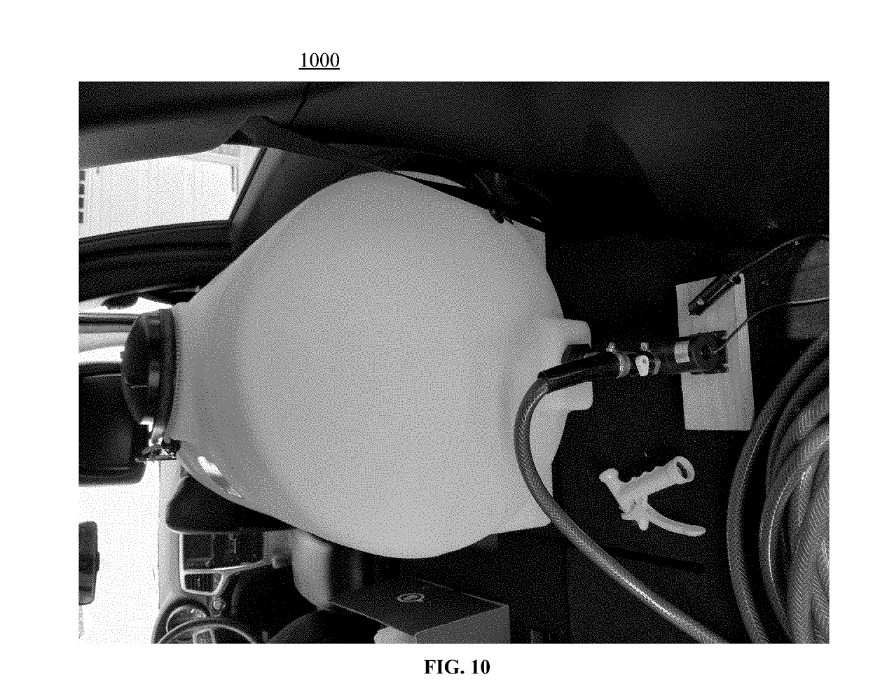

FIG. 10 is a perspective view of an exemplary embodiment of system 1000, which illustrates a different view from slightly above an elevation of the water tank.

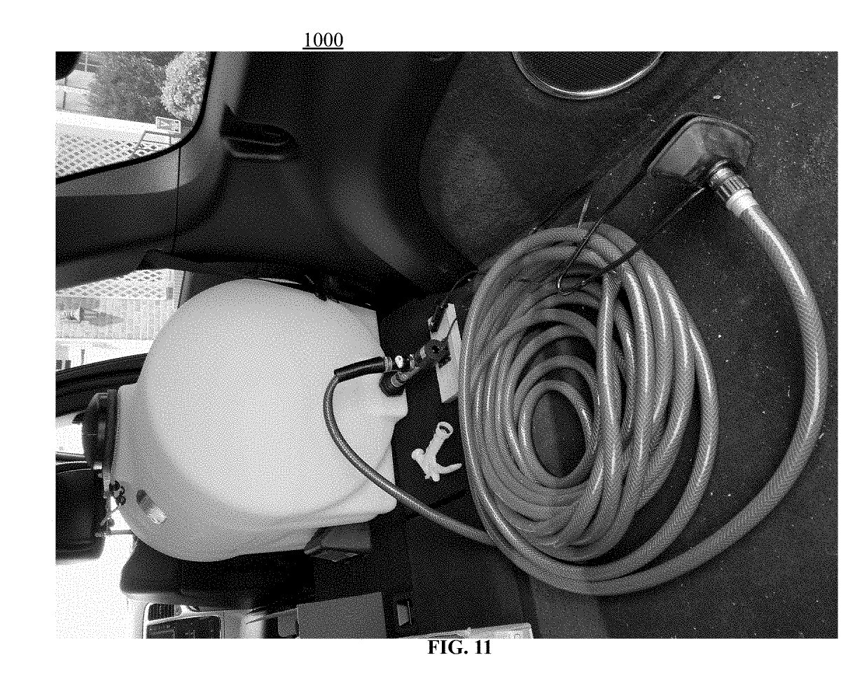

FIG. 11 is a perspective view of an exemplary embodiment of system 1000, which further illustrates the garden hose coupled to the marine boat motor flusher with rectangular cups.

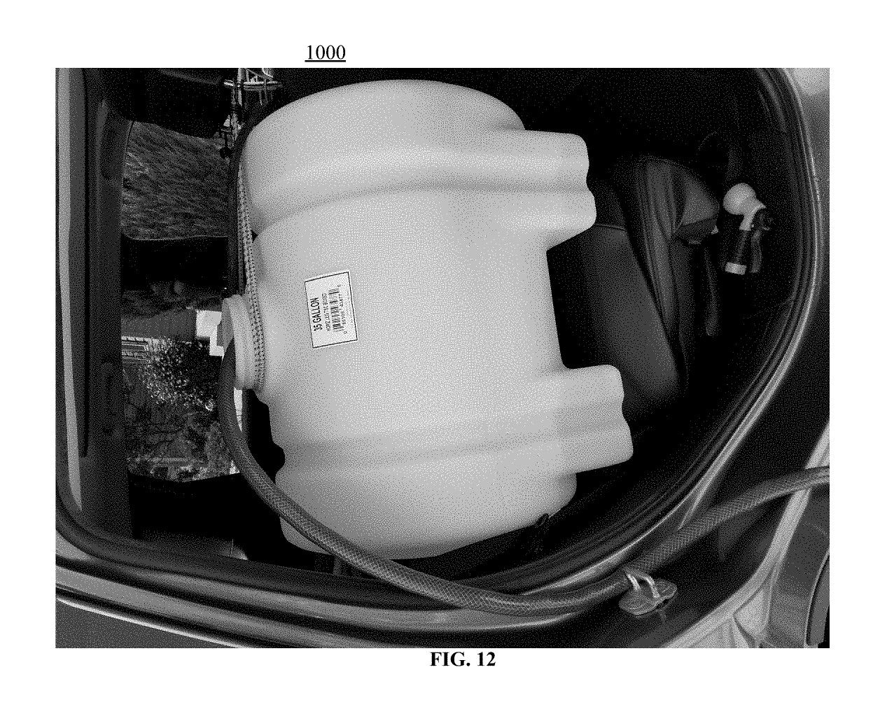

FIG. 12 is a perspective view of an exemplary embodiment of system 1000, which illustrates a flexible hose being used to add water to the water tank.

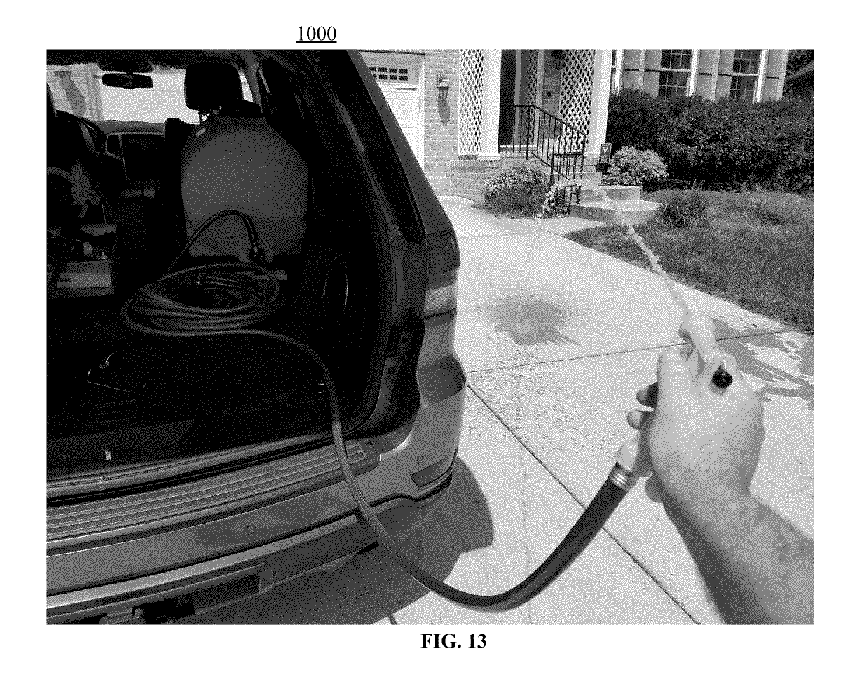

FIG. 13 is a perspective view of an exemplary embodiment of system 1000, which illustrates water being pumped from the water tank through the flexible hose and the nozzle. Water so provided can be used for flushing or cleaning a variety of devices, systems, and/or surfaces.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapter—a device used to effect operative compatibility between different parts of one or more pieces of an apparatus or system.
and/or—either in conjunction with or in alternative to.
apparatus—an appliance or device for a particular purpose.
aperture—an opening or hole.
associate—to join, connect together, and/or relate.
base—a bottom support of something.
battery—one or more electrochemical cells adapted to convert stored chemical energy into electrical energy.
cab—a compartment defined by a vehicle.
can—is capable of, in at least some embodiments.
close—to move from an open position.
comprising—including but not limited to.
configure—to make suitable or fit for a specific use or situation.
connect—to join or fasten together.
constructed to—made to and/or designed to.
convert—to transform, adapt, and/or change.
coupleable—capable of being joined, connected, and/or linked together.
coupling—linking in some fashion.
define—to establish the outline, form, or structure of
device—a machine, manufacture, and/or collection thereof.
discharge line—a tube through which a liquid passes through after being discharged by a pump.
electrically coupled—connected via one or more electrical conductors.
electrical energy—energy characterized by the flow of electric charge through a conductor.
electrical system—a set of components that provide electrical energy to electrical loads.
enclose—to substantially surround and something.
generate—to create by imparting energy.
flexible—capable of bending without breaking.
frame—a supporting structure.
hose—a tube constructed to direct water.
inlet—a part of a pump that receives a liquid prior to imparting energy to the liquid.
inside—housed within a compartment that is substantially surrounded by a shell
install—to connect or set in position and prepare for use.
marine boat motor flusher—an assembly that directs water into water intakes of an outboard motor. The assembly resembles a pair of earmuffs and has a water port at the approximate center of each of the pair of earmuffs. The assembly is constructed to releasably couple to the outboard motor during flushing.
may—is allowed and/or permitted to, in at least some embodiments.
method—a process, procedure, and/or collection of related activities for accomplishing something.
mount—to fix in a location via a releasable coupling.
obtain—to receive.
open—to move from a closed position.
oulet—a part of a pump that expels a liquid after imparting energy to the liquid.
placement—an act of putting something in a location.
plurality—the state of being plural and/or more than one.
port—a door or window of a vehicle.
portion—part.
power outlet—a receptacle coupled to energized electrical wires.
predetermined—established in advance.
pressure—a force applied perpendicular to the surface of an object over which that force is applied.
provide—to furnish, supply, give, and/or make available.
pump—a system that imparts energy to, and thereby moves, a liquid.
receive—to get as a signal, take, acquire, and/or obtain.
relative—in relationship to.
restrain—to limit movement of.
set—a related plurality.
spray nozzle—a device constructed to control a direction or characteristics of a fluid flow (especially to increase velocity) as it exits (or enters) an enclosed chamber or pipe. A spray nozzle is often a pipe or tube of varying cross sectional area, and it can be used to direct or modify the flow of a fluid.
store—to place, hold, and/or retain.
substantially—to a great extent or degree.
support—to bear the weight of, especially from below.
system—a collection of mechanisms, devices, machines, articles of manufacture, processes, data, and/or instructions, the collection designed to perform one or more specific functions.
valve—a device by which the flow of a fluid is started, stopped, and/or regulated by a movable part that opens, shuts, or partially obstructs one or more ports or passageways.
vehicle vehicle—a conveyance moving on wheels that transports persons and/or things. A vehicle can be a car, truck, sport utility vehicle or van, etc.
via—by way of and/or utilizing.
water pressure—energy that allows water to apply a force on a surface.
water tank—a vessel that stores a quantity of water.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a vehicle, the vehicle comprising a 12 volt DC power outlet, the 12 volt DC power outlet electrically coupled to a battery of the vehicle;
a water tank coupled to the vehicle;
a pump coupled to a water tank, the pump constructed to generate water pressure from electrical energy obtained from the 12 volt DC power outlet.

2. The system of claim 1, wherein:
an inlet port of the pump is coupled to a flexible hose.

3. The system of claim 1, wherein:
an outlet port of the pump is coupled to a flexible hose.

4. The system of claim 1, further comprising:
a base coupled to a frame of the pump.

5. The system of claim 1, further comprising:
a valve coupled to a discharge line of the pump.

6. The system of claim 1, further comprising:
a spray nozzle coupled to a flexible hose, the flexible hose coupled to an outlet port of the pump.

7. The system of claim 1, further comprising:
a marine boat motor flusher coupled to an outlet port of the pump via a flexible hose.

8. The system of claim 1, wherein:
the water tank is mounted inside of a cab of a vehicle, when all ports of the vehicle are closed, the water tank is substantially enclosed by the cab of the vehicle.
